(19) United States
(12) Patent Application Publication
(10) Pub. No.: US 2009/0092025 A1
(43) Pub. Date: Apr. 9, 2009

(54) APPARATUS AND METHOD FOR ERASING STORAGE MEDIUM

(75) Inventor: YUAN-MING CHUANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/967,121

(22) Filed: Dec. 29, 2007

(30) Foreign Application Priority Data
Oct. 9, 2007 (CN) 200710201962.3

(51) Int. Cl. G11B 7/00

(52) U.S. Cl. 369/100

(57) ABSTRACT

An apparatus includes an optical pick-up unit (OPU) and a controller. The OPU is used for irradiating light beam to the optical disc. The controller is used for driving the optical pick-up head to apply a plurality of first predetermined erasing powers to a first data area and a plurality of second predetermined erasing powers to a second data area. A first optimum erasing power and a second optimum erasing power are obtained respectively by ascertaining an optical property of the optical disc. The first optimum erasing power and the second erasing power are used for erasing data stored in different areas of the optical disc.

### BACKGROUND

1. Field of the Invention

The present invention generally relates to methods and apparatuses for erasing information stored in storage mediums, and more particularly, relates to a method and an apparatus for erasing an optical disc with data and/or programs stored therein.

2. Description of Related Art

Storage mediums such as optical discs having recording layers are used for recording information. The information is recorded by projecting laser beams to produce magnetic changes or phase changes.

FIG. 5 illustrates a side view of a conventional optical disc 100. The optical disc 100 is logically divided into a plurality of areas, such as a power calibration area (PCA) 102, a program memory area (PMA) 104, a lead-in area 106, a data area 108, and a lead-out area 110 in a radial direction. The PCA 102 located in an inner portion of the optical disc 100 is used as a testing area for determining an appropriate writing/erasing power level for writing/erasing laser beams.

Conventionally, an erasing power level of the laser beams is determined as below: firstly, a predetermined writing power is employed to write test data to the PCA 102; secondly, a plurality of predetermined erasing powers are employed to erase the test data; thirdly, an optimized erasing power level is calculated based on the predetermined erasing powers. The optimized erasing power is employed to erase data stored in the optical disc 100.

However, the optimized erasing power is related to the predetermined writing power, that is, variation of the predetermined writing power causes the optimized erasing power to be changed. The optimized erasing power is also varied as a practical writing power is often different from the predetermined writing power. Moreover, material characteristic between different areas of the optical disc may affect the optimized erasing power. As a result, the conventional erasing method and apparatus may not be able to achieve an optimized erasing power for erasing data stored in the optical disc.

Therefore, what is desired in the industry is to provide an erasing method and an erasing apparatus for obtaining an optimized erasing power for erasing data stored in the optical disc.

### SUMMARY

Accordingly, an apparatus is provided for erasing data stored in an optical disc. The apparatus includes an optical pick-up unit (OPU) and a controller. The OPU is used for irradiating light beams to the optical disc. The controller is used for driving the optical pick-up head to apply a plurality of first predetermined erasing powers to a first data area and a plurality of second predetermined erasing powers to a second data area. A first optimum erasing power and a second optimum erasing power are obtained respectively by ascertaining an optical property of the optical disc. The first optimum erasing power and the second erasing power are used for erasing data stored in different areas of the optical disc.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a top view of an optical disc according to an exemplary embodiment.

FIG. 2 is a side view of the optical disc as illustrated in FIG. 1.

FIG. 3 is a block diagram of a reproducing device for reproducing data stored in the optical disc as illustrated in FIG. 1.

FIG. 4 is a flow chart of a method of erasing data stored in the storage medium as illustrated in FIG. 1.

FIG. 5 is a side view of a conventional optical disc.

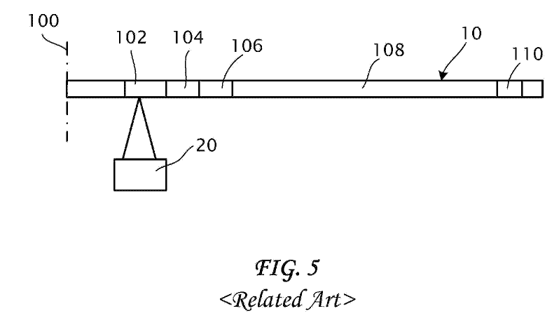

### DETAILED DESCRIPTION

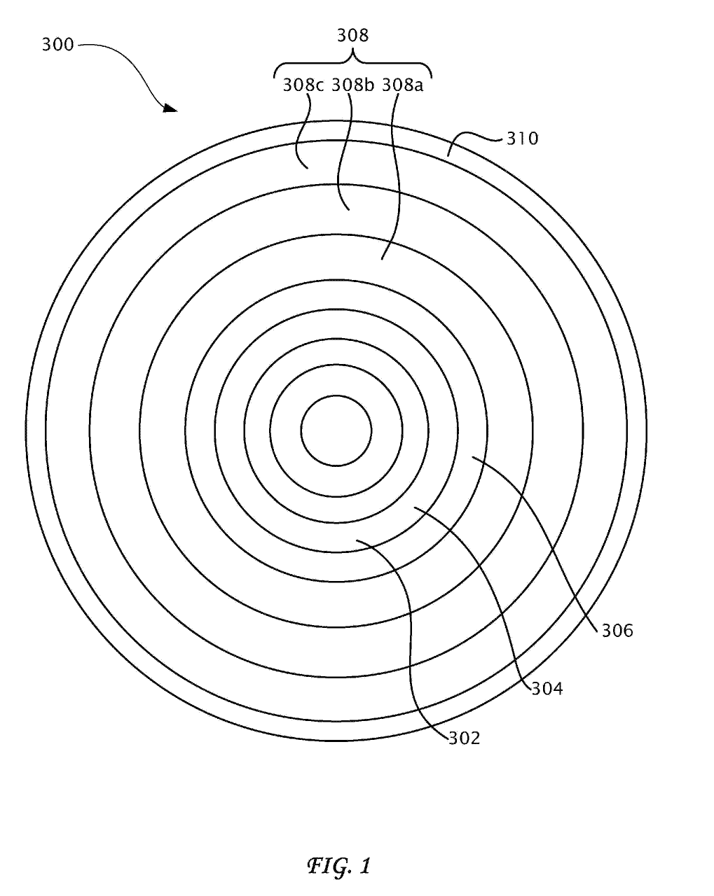

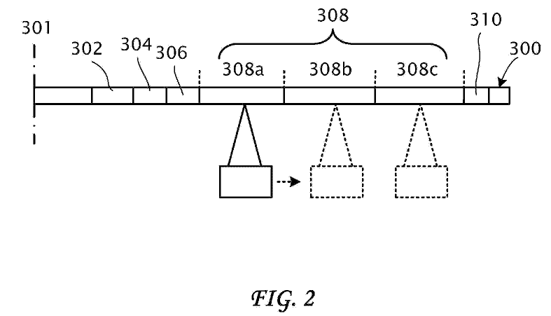

As a top view and a side view of a optical disc 300 shown in FIG. 1 and FIG. 2, the optical disc 300 is logically partitioned into a plurality of areas along a radial direction of the optical disc 300. These areas may include a power calibration area (PCA) 302, a program memory area (PMA) 304, a lead-in area 306, a data area 308, a lead-out area 310, and so on.

The PCA 302, located in an inner portion of the optical disc 300, is used for determining a writing/erasing power level for a writing/erasing laser beam. The PMA 304 following the PCA 302 in a radial direction is an intermediate storage area used for recording track information to the optical disc 300. The lead-in area 306 following the PMA 304 containing table information is used for marking a start of the optical disc 300. The data area 308 following the lead-in area 306 is used for storing encoded data relating to audio and video programs. The lead-out area 310 located in an outer portion of the optical disc 300 is used for indicating an end of the encoded data.

Further, the data area 308 is logically partitioned into three sub data areas, that is, a first sub data area 308a located adjacent to the lead-in area 306, a second sub data area 308b following the first sub data area 308a, and a third sub data area 308c following the second sub data area 308b and located adjacent the lead-out area 310. The first sub data area 308a is used for determining a first erasing power for erasing data stored in an inner portion of the optical disc 300, such as the lead-in area 306. The second sub data area 308b is used for determining a second erasing power for erasing data stored in the second sub data area 308b. The third sub data area 308c is used for determining a third erasing power for erasing data stored in an edge portion of the optical disc 300, such as the lead-out area 310.

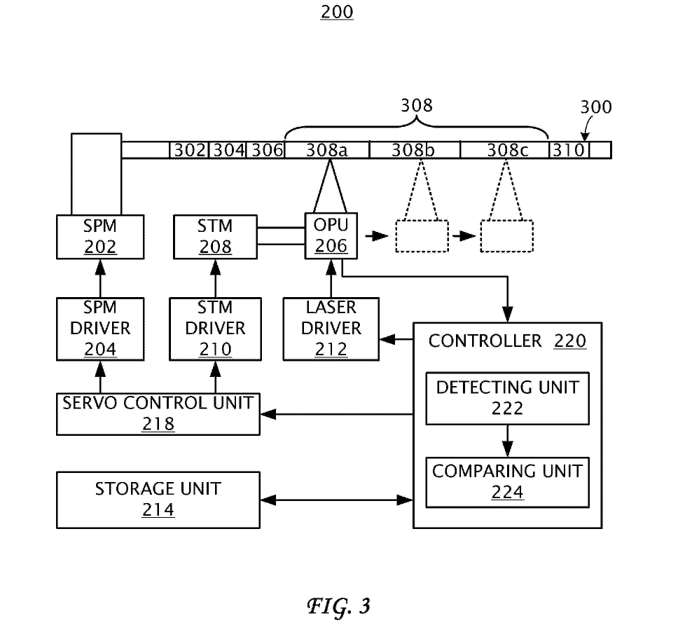

Referring to FIG. 3, an apparatus 200 such as a reproducing device used for erasing data stored in the optical disc 100 will be described hereinafter.

The reproducing apparatus 200 includes a spindle motor (SPM) 202, a SPM driver 204, an optical pick-up unit (OPU) 206, a stepping motor (STM) 208, a STM driver 210, a laser driver 212, a storage unit 214, a servo control unit 218, and a controller 220.

The SPM 202 is used for rotating the optical disc 300 at a predetermined speed under the control of the SPM driver 204. The OPU 206 is used for projecting laser beams to the optical disc 300 and receiving reflected laser beams from the optical disc 300 under the control of the laser driver 212, thus, data can be reproduced from or written to the optical disc 300. The STM 208 is used for actuating the OPU 206 to move radially with respect to the optical disc 300 under the control of the STM driver 210 for tracking data on the optical disc 300.

The SPM driver 204 and the STM driver 210 are electrically connected to the servo control unit 218, and the servo control unit 218 is electrically connected to the controller 220. The controller 220 is also connected to the laser driver 212, the OPU 206, and the storage unit 214. The controller 220 is configured for sending control signals to the laser driver 212, the servo control unit 218. The controller 220 is also capable of receiving the RF signals transmitted from the OPU 206.

The storage unit 214 may be a read-only memory (ROM) unit and is stored with various information such as a predetermined number of erasing powers Pea(x) (x=1, 2, 3, . . . ), Peb(y) (y=1, 2, 3, . . . ), and Pec(z) (z=1, 2, 3, . . . ). The predetermined erasing powers Pea(x) (x=1, 2, 3, . . . ), Peb(y) (y=1, 2, 3, . . . ), and Pec(z) (z=1, 2, 3, . . . ) are set for laser beams projecting to the first sub data area 308a, the second sub data area 308b, and the third sub data area 308c correspondingly. The various information stored in the storage unit 214 can be read by the controller 220.

The controller 220 includes a detecting unit 222 and a comparing unit 224. The detecting unit 222 may be used for detecting the amplitude of the RF signals obtained from the reflected laser beams from the sub data areas 308a, 308b, 308c. The comparing unit 224 connected to the detecting unit 222 is used for receiving a detecting result from the detecting unit 222 and obtaining a minimum result of the RF signals by comparing the detecting results with each other. Because the amplitude of the RF signal level is proportional to the intensity of the reflection, the results obtained may be used to represent reflection properties of the sub data areas 308a, 308b, or 308c, correspondingly.

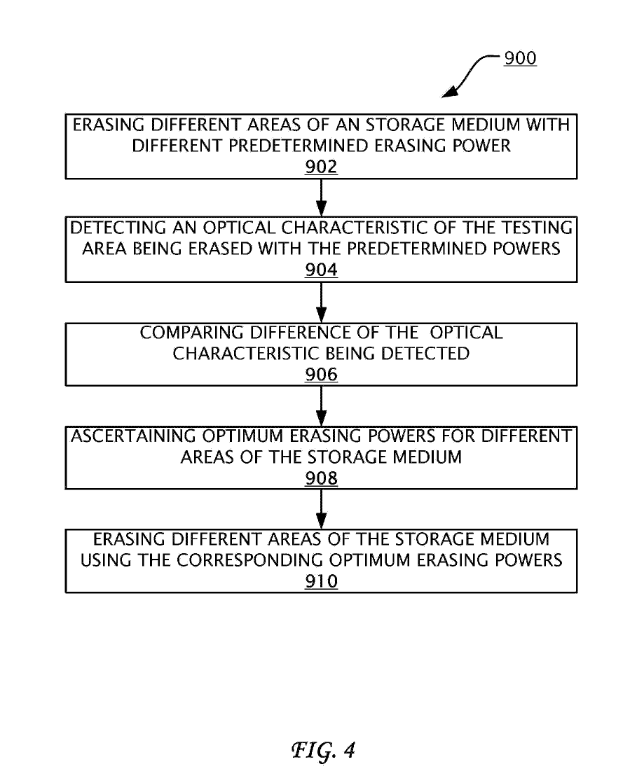

An operation of the reproducing device 200 for erasing the optical disc 300 with predetermined erasing powers will be described referring to a method 900 as illustrated in FIG. 4.

The method 900 is used for determining at least one erasing powers for the optical disc 300 with logically divided data areas 308a, 308b, and 308c. The various actions in the method 900 may be performed in the order presented, or may be performed in a different order, although the method 900 is not limited by the particular type of apparatus, software element, or system. Further, in some embodiments, some actions listed in FIG. 4 may be omitted from the method 900.

At block 902, an action of erasing testing areas stored with data with corresponding predetermined erasing powers is implemented. For example, the testing areas may include the data area 308 having the first sub data area 308a, the second sub data area 308b, and the third sub data area 308c. A number of first predetermined erasing powers Pea(x) (x=1, 2, 3, . . . ), for example, setting x to 5, are employed to erase data of the first sub data area 308a. Similarly, five second predetermined erasing powers Peb are employed to erase data of the second sub data area 308b, and five third predetermined erasing powers Pec are employed to erase data of the third sub data area 308c.

At block 904, an action of detecting an optical property of the data areas that are projected with laser beams with predetermined erasing powers is implemented. For example, reflection is used for evaluating the optical property of the testing areas being erased with the predetermined erasing powers. The reflection may be obtained by using the reproducing device 200 for irradiating a light beam to the optical disc 100 and receiving radio frequency (RF) signals obtained from reflected laser beams from the optical disc. Amplitudes of the RF signals are detected in the detecting unit 222 of the controller 220 and are used to represent the intensity of the reflection. Five first RF signals RFa(x) (x=1, 2, 3, 4, 5) may be obtained to represent the reflection of the first sub data area 308a being erased by the five first predetermined erasing powers Pea(x) (x=1, 2, 3, 4, 5) respectively. Five second RF signals RFb(x) (b=1, 2, 3, 4, 5) may be obtained to represent the reflection of the second sub data area 308b being erased by five second predetermined erasing powers Peb(x) (x=1, 2, 3, 4, 5) respectively. Five third RF signals RFc(x) (x=1, 2, 3, 4, 5) may be obtained to represent the reflection of the third sub data area 308c being erased by five third predetermined erasing powers Pec(x) (x=1, 2, 3, 4, 5) respectively.

At block 906, an action of comparing the optical property such as the reflection of the data areas being erased is implemented. As the amplitude of the RF signal is proportional to the intensity of the reflection. Therefore, a minimum reflection of the different data areas can be obtained by comparing the RF signals in the comparing unit 224 of the controller 220. For example, a first minimum reflection of the first sub data area 308a can be obtained by comparing the five first RF signals RFa(x) (x=1, 2, 3, 4, 5). A second minimum reflection of the second sub data area 308b can be obtained by comparing the five second RF signals RFb(x) (x=1, 2, 3, 4, 5). A third minimum reflection of the third sub data area 308c can be obtained by comparing the five third RF signals RFc(x) (x=1, 2, 3, 4, 5).

At block 908, an action of ascertaining optimum erasing power for the data areas being erased with predetermined erasing powers of the optical disc is implemented. As is known, there is a relationship between the reflection and the erasing power, that is, the better the erasing power applied to the testing area, the lower the reflection and the corresponding amplitude of the RF signals. Therefore, an optimum erasing power may be ascertained by the comparing the reflection. The first optimum erasing power is ascertained from one of the first predetermined erasing powers Pea(x) (x=1, 2, 3, 4, 5) corresponding to the first minimum reflection. The second optimum erasing power is ascertained from one of the second predetermined erasing powers Peb(x) (x=1, 2, 3, 4, 5) corresponding to the second minimum reflection. The third optimum erasing power is ascertained from one of the third predetermined erasing powers Pec(x) (x=1, 2, 3, 4, 5) corresponding to the third minimum reflection.

At block 910, an action of erasing the optical disc by applying different optimum erasing powers to different data areas is implemented. For example, the first optimum erasing power is applied to erase the first sub data area 308a, the lead-in area 306, the PMA 304, and the PCA 302. The second optimum erasing power is applied to erase the second sub data area 308b. The third optimum erasing power is applied to erase the third sub data area 308c and the lead-out area 310.

Therefore, as the reproducing device 200 and the method 900 described above, the lead-in area 306, the PMA 304, and the PCA 302 are located adjacent to the first sub data area 308a having substantially the same material characteristics, such that using the first optimum erasing power to erase these areas may be able to achieve a better erasing effect. Likewise, the lead-out area 310 is located adjacent to the third sub data area 308c having substantially the same material characteristics, such that using the third optimum erasing power to erase these areas may also be able to achieve a better erasing result.

Alternative embodiments will become apparent to those skilled in the art to which the present invention pertains without departing from its spirit and scope.

What is claimed is:

1. An apparatus for erasing data stored in an optical disc, comprising:
an optical pick-up head for irradiating light beams to the optical disc; and
a controller for driving the optical pick-up head to apply a plurality of first predetermined erasing powers of irradiating light beams to a first data area and a plurality of second predetermined erasing powers to a second data area, a first optimum erasing power selected from one of the first plurality of predetermined erasing powers and a second optimum erasing power selected from one of the second plurality of erasing powers are obtained respectively by ascertaining an optical property of the optical disc, the first optimum erasing power and the second erasing power being used for erasing data stored in different areas of the optical disc respectively.

2. The apparatus as described in claim 1, wherein the first data area and the second data area are located substantially in a central portion of the optical disc.

3. The apparatus as described in claim 1, wherein the optical property of the optical disc are reflections of light beams reflected from the optical disc.

4. The apparatus as described in claim 1, wherein the first optimum erasing power is used to erase a lead-in area indicating a start of data of the optical disc.

5. The apparatus as described in claim 1, wherein the second optimum erasing power is used to erase a lead-out area indicating an end of data of the optical disc.

6. The apparatus as described in claim 1, wherein a plurality of third predetermined erasing powers are applied to a third data area located between the first data area and the second data area of the optical disc, a third optimum erasing power is selected from one of the plurality of third predetermined erasing powers by ascertaining the reflection of the light beams reflected from the third data area.

7. A method for erasing data stored in an optical disc, comprising:
erasing a first data area and a second data area of the optical disc with a plurality of first predetermined erasing powers and second predetermined erasing powers of irradiating light beams, correspondingly;
detecting an optical property of the first data areas and the second data areas being erased with predetermined erasing powers;
ascertaining a first optimum erasing power selected from one of the plurality of first predetermined erasing powers and a second optimum erasing power selected from one of the plurality of second predetermined erasing powers; and
erasing different areas of the optical disc by applying the first optimum erasing power and the second optimum erasing power thereto respectively.

8. The method as described in claim 9, further comprising:
comparing a reflection of the optical property of the first data area to obtain the first optimum erasing power and comparing a reflection of the optical property of the second data area to obtain the second optimum erasing power.

9. The method as described in claim 9, further comprising:
erasing a lead-in area and the first data area using the first optimum erasing power.

10. The method as described in claim 9, further comprising:
erasing a lead-out area and the second data area using the second optimum erasing power.

11. The method as described in claim 9, further comprising:
erasing a third data area located between the first data area and the second data area of the optical disc with a plurality of third predetermined erasing powers; and
ascertaining a third optimum erasing power selected from one of the plurality of third predetermined erasing powers.
